(19) United States
(12) Patent Application Publication
(10) Pub. No.: US 2016/0190867 A1
(43) Pub. Date: Jun. 30, 2016

(54) SCALABLE HYBRID BACKUP ENERGY STORAGE SYSTEM WITH INTEGRATED CONTROL FOR EXTENDED OPERATIONAL LIFE

(71) Applicant: Rosana Esteller, Marietta, GA (US)

(72) Inventors: Antonio Efrain Ginart, Marietta, GA (US); Rosana Esteller, Marietta, GA (US)

(73) Assignee: Antonio Efrain Ginart, Marietta, GA (US)

(21) Appl. No.: 14/980,969

(22) Filed: Dec. 28, 2015

Related U.S. Application Data
(60) Provisional application No. 62/097,236, filed on Dec. 29, 2014.

(51) Int. Cl. H02J 9/06; H02J 3/38

(52) U.S. Cl. CPC H02J 9/061; H02J 9/066; H02J 3/383; H02J 3/386; H02J 3/387; H02J 3/382

(57) ABSTRACT

A low-cost hybrid backup energy system that consists of (1) a battery bank that includes one or more power converters, (2) DC-link capacitors, (3) a compressed air energy storage system, that is composed of an air compressor(s), one or more gas storage tanks, one or more efficient pneumatic motors, pressure regulators, one or more electrical generators, and one or more power converters, and (4) one integrated master controller. This hybrid system is used to provide uninterrupted, immediate, and sustained DC energy supply when outages occur to feed power converters (AC) such as a UPS or similar for long or intermediate durations of time to allow uninterrupted operations in data centers, hospitals, telecommunication stations, and other critical loads. In other embodiments, this system facilitates a reliable transition to longer duration type of energy generators such as diesel, gas, fuel cells, or others. The strategy used in this system reduces the amount of batteries required and at the same time minimizes deeper battery discharges prolonging battery life in comparison to standard backup systems. As a result the whole system provides longer operational life spans.

### FIELD OF INVENTION

This invention relates to the area of hybrid energy storage systems using at least two or more energy storage and/or supply approaches as an alternate way to provide energy when an outage occurs under the supervision of a master integrated control that determines when to trigger the different systems. More particularly, this invention refers to creating low-cost solutions to provide uninterrupted and sustained energy supply during the occurrence of outages to critical locations such as data centers, hospitals, telecommunications stations, emergency communication facilities, laboratories, manufactures of critical production products or equipment, military bases, certain government facilities, and others less critical but with a desired power quality supply such as residential homes and office buildings. Some of the energy storage approaches considered as alternate ways to supply energy to critical loads when outages occur include compressed air or other fluid energy storage, battery banks, super-capacitors, induction energy storage, fuel cell banks, and flywheel energy storage.

### BACKGROUND OF THE INVENTION

Backup power systems that consist in only batteries or batteries combined with a later transition to unreliable diesel systems (arranged in parallel to increase reliability) are the norm for data centers, telecommunications stations, hospitals, and others. Even though battery performance continues to improve over time, the cost of battery systems remains high, with the most expensive batteries, the lithium ion ones, achieving durations in the order of 2000 cycles or more, the less expensive lead acid batteries with durations in the order of 200 cycles. In addition, they require a great control of ambient temperature besides a rigorous maintenance and monitoring. As a consequence, battery systems have to be replaced every two to five years, depending on the battery technology and usage. On the other hand, air-compressed systems have been used in power systems to store energy during off peak hours to increase the efficiency of combustion engines during peak energy-demand.

The limitation of pure air-compressed energy storage systems have been the low efficiency of the compression and decompression (see Rice and Li “Optimal Efficiency-Power Tradeoff for an Air Motor/Compressor With Volume Varying Heat Transfer Capability” Dynamic Systems and Control Conference and Bath, USA, pp. 145-152, 2011). More recently, the efficiency of pure air compressed systems has been increased to almost 60% maintaining an adiabatic process (see Rufer and Lemofouet “Energetic Performance of a Hybrid Energy Storage System based on Compressed Air and Super Capacitors” published in the Symposium on Power Electronics, Electrical Drives, Automation & Motion, Italy, May 2006, also Dein Shaw, Jyun-jhe Yu, and Cheng Chieh “Design of a Hydraulic Motor System Driven by Compressed Air” Energies, 2013, vol. 6, issue 7, pages 3149-3166, and U.S. Pat. No. 8,117,842 and No. 8,234,868). The heat released during compression is fed back to the system during expansion. Other proposed solution to increase efficiency has been combining air and hydraulic fluids. In parallel, more efficient air motors have been developed for automobiles (see U.S. Pat. No. 6,868,822). But even though these motors claim efficiency greater than 90%, the deployment to the field is limited due to the low energy density typically achievable with air compression; yielding low-range vehicles. For the reasons explained above, we proposed an application that takes the advantages of air-compressed systems and minimizes the disadvantages

An example of a hybrid energy storage system that does not optimizes for extended operational life can be seen in U.S. Pat. No. 8,754,547.

### DESCRIPTION

Uninterruptible backup energy systems have the main goal to keep seamless operation of the equipment attached to the backup storage system during power outages. In order to achieve this, traditional systems are based on a DC-link capacitor, a large battery bank, and possibly a group of diesel and gas generators. The key to uninterrupted energy supply is in the response time of the different parts of the backup system. The response time of the capacitors is in the order of nanoseconds or microseconds and they are the insurance of the interruptible power system supply, follow by the batteries that have a response time in the order of milliseconds. For longer backup supply duration, energy backup systems use traditional AC diesel generators that are in standby mode in the backup system and have response times in the order of many seconds to minutes. The diesel generator needs to wait the proper speed to create the 60 (or 50 Hz) needed in power systems. In this invention, an ultrafast or fast, previously charged air-based energy backup system is attached to the DC-link. The startup of this system is designed to be a constant time of about a couple of seconds. This system accomplishes two main functions. It reduces the amount of batteries required and greatly decreases the energy demand and stress on the used batteries; this is achieved thanks to the addition of the air-based backup system that begins reliable operation after about a couple seconds of the outage.

The key factor to accomplish a short startup time for the air-based backup system is to use discrete sets of air-based/energy-generator units that operate at a few kilowatts each. The number of these units is scalable to satisfy the total power required in the specific application. These small pneumatic-motor/electrical generator units have intrinsically small momentum of inertia and as a consequence produce a fast startup time compared to a larger single unit designed to provide the whole power required.

Using the hybrid approach described, the battery bank can be minimized up to 80% of the typical full battery design and the battery energy deep cycles required can be reduced, therefore extending their life. This patent proposes the full control and interaction of the system taking into account the paradigm that the faster energy providers are the capacitors, with time constants close to nanoseconds, followed by the batteries with time constants of milliseconds, and lastly the air-compressed energy generation with time constants of one or two seconds. They are ten to one hundred times faster than diesel or gas generators.

This has the advantage that the number of back-up diesel generators can be reduced because the reliability and availability of air-compressed generators are considerably greater than that of combustion-based generators. The energy density of compressed air at low pressure is not high and possesses restrictions because numerous and large-volume tanks are needed for energy storage. This can be mitigated because these tanks can be placed outdoors, allowing the ability to pile large amounts of exterior storage tanks. High air pressure systems can be used as an alternative when space is limited or when viability cost analyses suggest their usage.

New trends of energy backup systems based on air try to maximize the efficiency in a reversible adiabatic process. In this invention, while efficiency is important, it is not the main point. The crucial aspect is a very fast startup activation of the air-generator units to optimize the battery life and dimensioning. Therefore the process of energy charging (air compression) and energy generation is separated in two stages conducted by the compression system and the air-based electricity generation system. The latter is discretized in small air-based/energy-generator units for fast response time.

### BRIEF DESCRIPTION OF THE DRAWING

FIG. 1 is schematic diagram of the present invention.

### DETAILED DESCRIPTION OF THE DRAWING

It depicts the hybrid energy backup system 100. It is composed of (1) a battery bank 120 that includes the batteries 122 and one or more power converters 124 that allow connection to the DC link, (2) DC-link capacitors 160, (3) the air-based energy backup system 200 that comprises (a) the energy charging and storage system 240 and the energy release system 280. The energy charging and storage system is composed of one or more compressor motors 241, one or more air compressors 242, one or more gas storage tanks 244, one input valve per gas storage tank 243. The energy release system 280 consists of one or more pneumatic motors 282, one or more pressure regulators 283, one or more output valves from the tanks 285, one or more electrical generators 287, and one or more power converters 284, and (4) an integrated system master controller 300 that senses the grid status through the sensing unit 400.

The master controller 300 is the heart of the system in charge of controlling the main two phases of operation. The operation phases are: (1) energy charging and standby-sensing mode; (3) backup energy generation.

Energy Charging

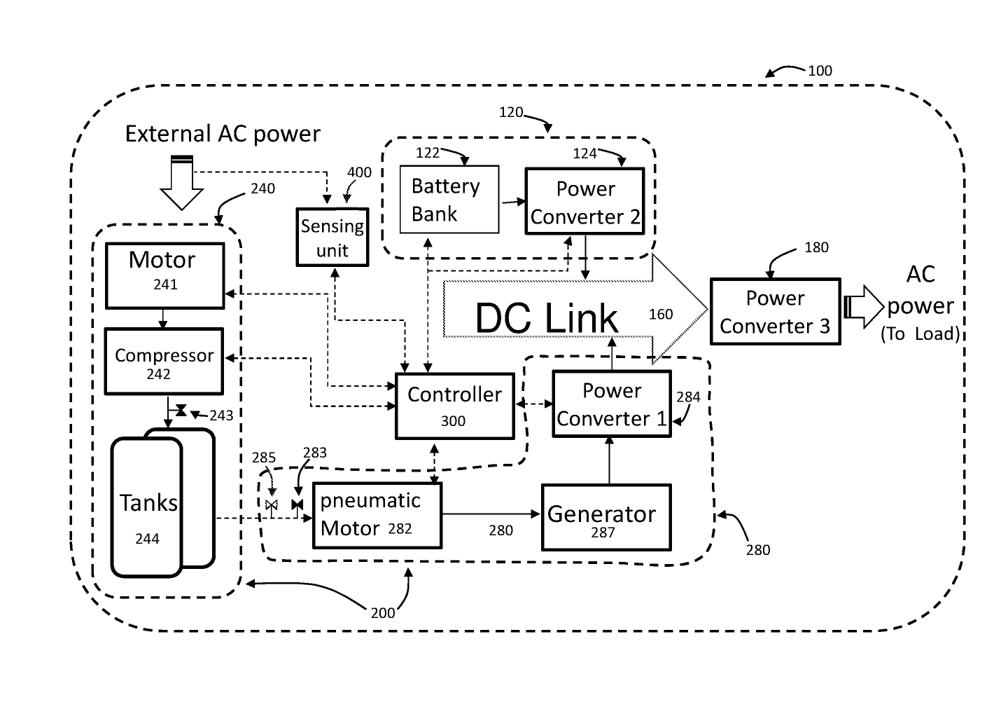

During this phase, the tanks are charged with compressed air. The energy charging occurs right after the system is installed. Using external available energy the master controller 300 and the motor(s) 241 in FIG. 1 are turned on to allow the air compressor charge the tank(s) to the operating pressure. The pressure level is maintained by the master controller within a narrow band. The charging process is designed to consider cost optimization rather than speed optimization. Once the tanks reach the operating pressure, the system changes to the standby sensing mode, where the master controller monitors different variables to maintain the system readiness in case of an outage. If the pressure falls below the minimum acceptable the control senses it and activates the energy charging again to keep the pressure within the appropriate band.

If an outage occurs, the backup energy generation phase immediately triggers to provide uninterrupted electricity to the desired facilities or equipment that are appropriately connected to the UPS (power converter) 180. The UPS acts using first the energy stored in the capacitors, very shortly after, the battery bank starts operation with simultaneous turned on of the tank release valve. The air flows from the tank(s) to the pneumatic motor(s) whose movement activates the generator motor(s) in around two seconds. The power converters receive the electrical energy from the generator and supply it to the DC link. As the air-based backup system releases its stored energy, the master controller decreases the demand on the battery bank accordingly until the battery bank is not providing anymore energy; this process takes a few seconds.

The proposed system is scalable at the energy generation and storage phase, also the ratio of different source of energy storage can be modified. This allows to discretely adjust the amount of energy stored and also to adjust the amount of energy delivered.

What is claimed is:

1. A hybrid energy storage system to supply energy to an external load comprising:
a battery bank,
DC-link capacitors,
a reliable fast acting extra energy storage,
at least one energy sensor, and
a master control that manages and commands all the system parts, including the activation of energy delivery from the fast acting extra energy storage early in time when the battery bank has delivered part of its charge.

2. The system of claim 1, wherein the master control senses an energy need and immediately supplies the stored energy to provide uninterrupted and sustained DC energy to feed power converters (AC) such as a UPS or similar.

3. The system of claim 1, wherein the master control to determines the appropriate time to to recharge each of the energy storage systems.

4. The system of claim 1, wherein the master control avoids power outages activating the reliable fast acting extra energy storage available to support the battery energy system.

5. The system of claim 1 where the external load is a data center, a hospital, a telecommunication station, an emergency communication facility, a laboratory, a manufacture of critical production products or equipment, a military base, a government facilities, a residential home, or an office building.

6. The system of claim 1, wherein the reliable fast acting extra energy storage is a compressed air energy storage system.

7. The system of claim 1, wherein the battery bank includes at least one power converter

8. The system of claim 6, wherein the compressed air energy storage system comprises:
at least one air compressor(s),
at least one gas storage tank,
at least one efficient pneumatic motor,
at least one pressure regulator,
at least one electrical generator, and
at least one power converter.

9. The system of claim 6, wherein the master control sends appropriate commands to activate or deactivate each of the system parts to maximize extended operational life.

10. The system of claim 6, wherein the master control manages the state of charge of the battery system and avoids extreme discharge or overcharge of the battery cells to extend the batteries life span.

11. The system of claim 6, wherein the master control activates the energy supply from the battery bank, then transitions the energy supply, by activating the energy release from the compressed air energy storage, and lastly, if required, the master control activates at least one additional third energy generator.

12. The system of claim 11, wherein the master control determines if recharging of the battery bank and/or recharging of the compressed air energy storage system is appropriate when at least one additional energy generator is supplying energy to the load.

13. The system of claim 10, wherein the additional energy generator works with diesel, gas, fuel cells, or others to provide uninterrupted energy supply.

14. The system of claim 10, wherein the other energy generation is supplied by a renewable source of energy such as solar or wind.
